(19) United States
(12) Patent Application Publication
(10) Pub. No.: US 2012/0285573 A1
(43) Pub. Date: Nov. 15, 2012

(54) FLEXIBLE SHOWER ARM

(76) Inventor: Nam Soo PAIK, Los Angeles, CA (US)

(21) Appl. No.: 13/465,609

(22) Filed: May 7, 2012

Related U.S. Application Data
(60) Provisional application No. 61/484,807, filed on May 11, 2011.

(51) Int. Cl. F16L 11/00

(52) U.S. Cl. 138/120

(57) ABSTRACT

A flexible shower arm includes a shaft pipe and a flexible spout. The shaft pipe comprises first and second end portions, first and second straight pipe portions, and a bent portion. The first end portion is connected to the water supply pipe provided generally horizontally. The flexible spout includes first and second end portions. The first end portion is connected to the second end portion of the shaft pipe. The first and second straight pipe portions meet each other at the bent portion with a predetermined angle so as to reduce water pressure and to prevent the flexible spout from being straightened out because of the water pressure. An overall shape of the flexible spout is adjusted so that a vertical location and an angular position of the second end portion of the flexible spout are adjusted.

### RELATED APPLICATION

This application is a non-provisional application corresponding to Provisional U.S. Patent Application Ser. No. 61/484,807 for “Flexible Shower Arm” filed on May 11, 2011.

### BACKGROUND OF THE INVENTION

The present invention relates to a flexible shower arm.

The flexibility and adjustability of conventional shower arms are limited in that a user can only adjust the direction of a shower head or the extent of which a user can adjust the shower arm is limited. Conventional shower arms, even if the direction is controllable, are not configured to be fixable at any selected angular position whereby a user can direct a water stream to a specific point of body.

Solutions to the above problems of shower arms have been suggested with partial success.

Even though they look simple, the above problems are related to fluid dynamics and material and full solutions had not come out.

Accordingly, a need for a flexible shower arm has been present for a long time considering the expansive demands in the everyday life. This invention is directed to solve these problems and satisfy the long-felt need.

### SUMMARY OF THE INVENTION

The present invention contrives to solve the disadvantages of the prior art.

An object of the invention is to provide a flexible shower arm.

Another object of the invention is to provide a flexible shower arm, in which the height and direction of a shower head can be adjusted conveniently.

A flexible shower arm for a water supply pipe comprises a shaft pipe and a flexible spout.

The shaft pipe comprises a first end portion, a first straight pipe portion, a bent portion, a second straight pipe portion, and a second end portion, and the first end portion is configured to be connected to the water supply pipe provided generally horizontally.

The flexible spout comprises a first end portion and a second end portion, and the first end portion is configured to be connected to the second end portion of the shaft pipe.

The first and second straight pipe portions meet each other at the bent portion with a predetermined angle so as to reduce water pressure and to prevent the flexible spout from being straightened out because of the water pressure.

An overall shape of the flexible spout is adjusted so that a vertical location and an angular position of the second end portion of the flexible spout are adjusted.

The first end portion of the shaft pipe may have male threads to be received by a female threaded receiver in communication with the water supply pipe.

The second end portion of the shaft pipe may be integrated with the first end portion of the flexible spout.

The second end portion of the flexible spout may be configured to be connected to a shower head.

The second end portion of the flexible spout may comprise male threads adapted to be received by female threaded receiver of the shower head.

The predetermined angle of the bent portion of the shaft pipe may be from about 120 degrees to about 135 degrees.

The bent portion of the shaft pipe may be smoothly curved so as to prevent water flow therethrough from being turbulent.

The flexible spout may be sturdy enough to keep a shape given by a user under a predetermined water pressure.

The vertical position of the second end portion of the flexible spout may be elevated by pushing the second end portion of the flexible spout upward or diagonally.

The angular position of the second end portion of the flexible spout may be changed by pushing, pulling, and twisting the second end portion of the flexible spout.

The flexible spout may be maintained substantially straight within a predetermined length from each of the first and second end portion of the flexible spout.

The flexible spout may be configured to curved without a sharp angle.

The advantages of the present invention are: (1) the flexible shower arm is easy to adjust the height and direction; and (2) the flexible shower arm is convenient to be installed to a regular water supply pipe.

Although the present invention is briefly summarized, the fuller understanding of the invention can be obtained by the following drawings, detailed description and appended claims.

### BRIEF DESCRIPTION OF THE DRAWINGS

These and other features, aspects and advantages of the present invention will become better understood with reference to the accompanying drawings, wherein:

FIG. 1 is a partially cross-sectional perspective view showing a flexible shower arm according to an embodiment of the present invention;

FIG. 2 is a partially cross-sectional perspective view showing the flexible shower arm of FIG. 1 with the spout disposed in a first shape;

FIG. 3 is a partially cross-sectional perspective view showing the flexible shower arm of FIG. 1 with the spout disposed in a second shape;

FIG. 4 is a partially cross-sectional perspective view showing the flexible shower arm of FIG. 1 with the spout disposed in a third shape; and

FIG. 5 shows diagrams showings the spout disposed in many different ways.

### DETAILED DESCRIPTION EMBODIMENTS OF THE INVENTION

The present invention relates to a flexible shower arm configured to fit within a pre-existing water supply line generally associated with bathtubs and shower stalls. The flexible shower arm comprises a shaft and a flexible spout. The first end of the shaft has preferably male threads to be received by a generally horizontally oriented female threaded receiver in communication with a water supply pipe inside a wall. The second end of the shaft is integrated with first end of the flexible spout. Second end of the flexible spout is configured to be connected to a shower head. Preferably, the second end of the flexible spout has male threads to be received by female threaded receiver of the shower head. The shaft is bent at a pre-determined angle to reduce water pressure and to prevent the flexible spout from being straightened because of high water pressure therein.

Accordingly, a need for a flexible shower arm that a user can freely adjust the direction of water stream. The present invention contrives to solve the disadvantages of the prior art. The object of the invention is to provide a flexible shower arm comprising a shaft and a flexible spout. The flexible shower arm is configured to conveniently fit within a pre-existing water supply line.

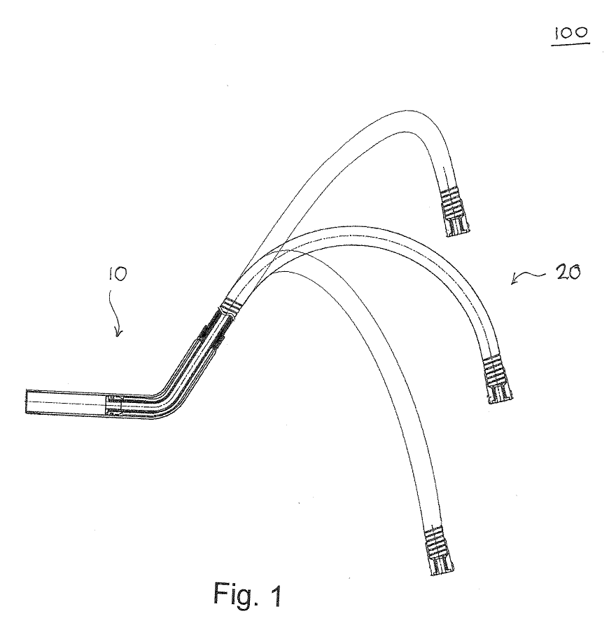

FIG. 1 shows the flexible shower arm. With the flexible shower arm, a user can adjust the location and angular position of the shower head. The flexible spout is flexible and self-supporting at fixable positions. The shower head is attached to the second end of the flexible spout. A user can vertically adjust, up to three feet, the height of the shower head.

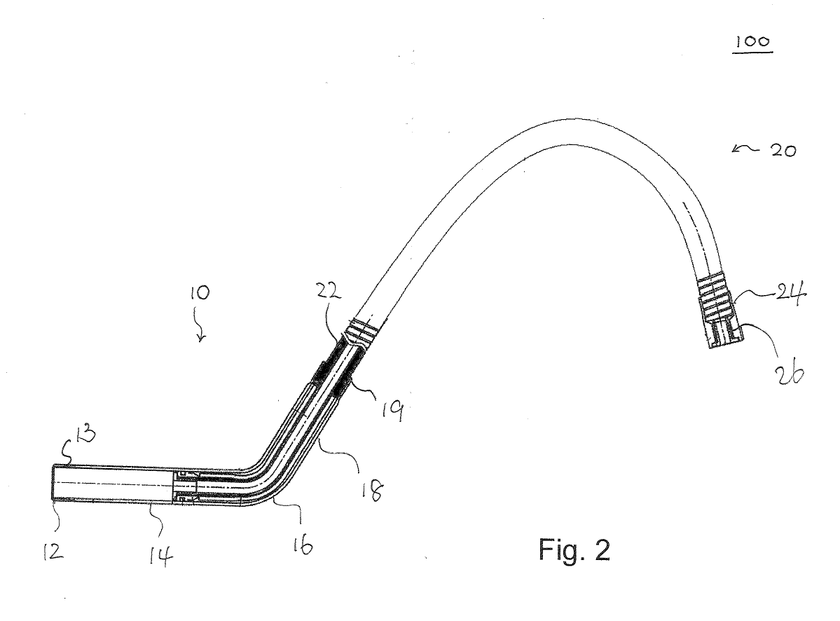

FIG. 2 shows dimensions of each element of the flexible shower arm. The preferable pre-determined angle for the shaft was determined by repetitive experiments to prevent the flexible spout from being straightening due to high water pressure therein. FIG. 2 shows the preferable embodiment and the dimensions may change to suit a specific demand.

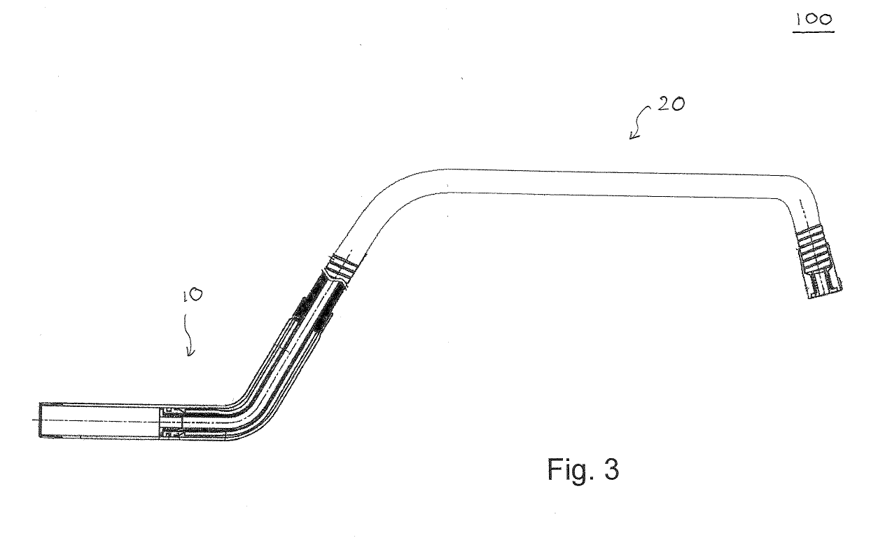

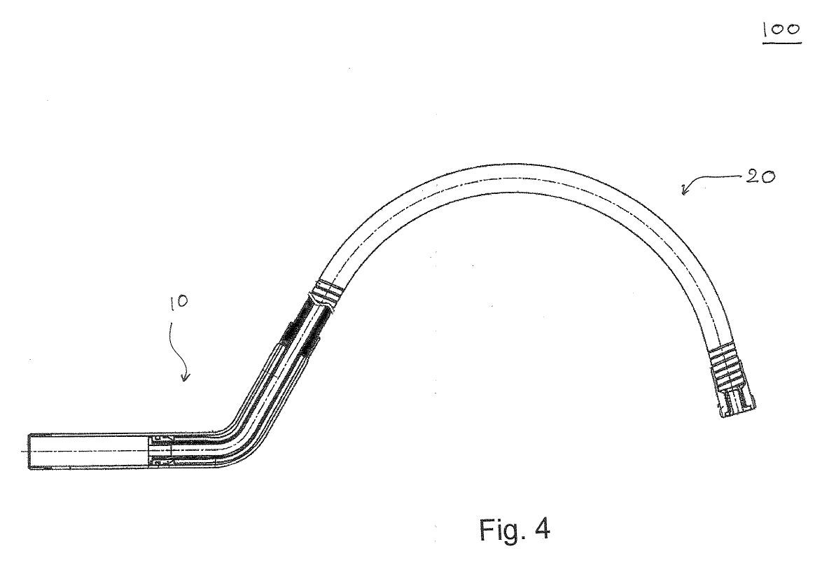

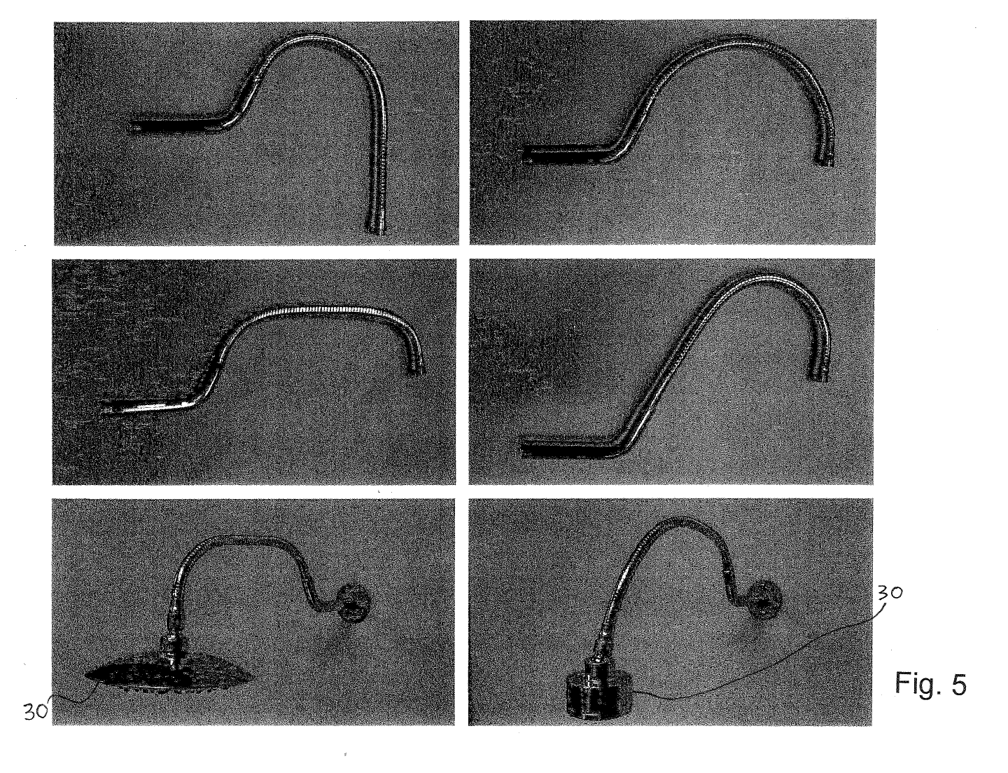

FIGS. 3 and 4 show additional dimensions for the flexible shower arm. FIG. 5 shows photos of actual embodiment of the invention.

An object of the invention is to provide a flexible shower arm.

Another object of the invention is to provide a flexible shower arm, in which the height and direction of a shower head can be adjusted conveniently.

A flexible shower arm 100 for a water supply pipe comprises a shaft pipe 10 and a flexible spout 20 as shown in FIG. 1.

The shaft pipe 10 comprises a first end portion 12, a first straight pipe portion 14, a bent portion 16, a second straight pipe portion 18, and a second end portion 19, and the first end portion 11 is configured to be connected to the water supply pipe (now shown) provided generally horizontally as shown in FIG. 2.

The flexible spout 20 comprises a first end portion 22 and a second end portion 24, and the first end portion 22 is configured to be connected to the second end portion 19 of the shaft pipe 10 as shown in FIG. 2.

The first and second straight pipe portions 14, 18 meet each other at the bent portion 16 with a predetermined angle so as to reduce water pressure and to prevent the flexible spout 20 from being straightened out because of the water pressure.

An overall shape of the flexible spout 20 is adjusted so that a vertical location and an angular position of the second end portion 24 of the flexible spout 20 are adjusted as shown in FIGS. 1 and 5.

The first end portion 12 of the shaft pipe 10 may have male threads 13 to be received by a female threaded receiver in communication with the water supply pipe as shown in FIG. 2.

The second end portion 19 of the shaft pipe 10 may be integrated with the first end portion 22 of the flexible spout 20. In certain embodiments of the invention, they can be manufactured integrally or non-detachably.

The second end portion 24 of the flexible spout 20 may be configured to be connected to a shower head 30 as shown in FIG. 5.

The second end portion 24 of the flexible spout 20 may comprise male threads 26 adapted to be received by female threaded receiver of the shower head 30 as shown in FIG. 2.

The predetermined angle of the bent portion 16 of the shaft pipe 10 may be from about 120 degrees to about 135 degrees as shown in FIGS. 1-6. However, the predetermined angle can be adjusted for a given situation such as water pressure of the water supply device. If the water pressure is too high in the water supply device, the predetermined angle can be substantially a 90 degrees or smaller.

The bent portion 16 of the shaft pipe 10 may be smoothly curved so as to prevent water flow therethrough from being turbulent as shown in FIG. 1. Of course, in certain embodiments of the invention, the bent portion 16 of the shaft pipe 10 may be sharply curved as long as it does not impart the water flow a big turbulence.

The flexible spout 20 may be sturdy enough to keep a shape given by a user under a predetermined water pressure, so that once the user bends the flexible spout 20 this or that way, it may stay in that shape for a prolonged time period.

The vertical position of the second end portion 24 of the flexible spout 20 may be elevated by pushing the second end portion 24 of the flexible spout 20 or the shower head 30 upward or diagonally.

The angular position of the second end portion 24 of the flexible spout 20 may be changed by pushing, pulling, and twisting the second end portion 24 of the flexible spout 20.

The flexible spout 20 may be maintained substantially straight within a predetermined length from each of the first and second end portions 22, 24 of the flexible spout 20.

The flexible spout 20 may be configured to curved without a sharp angle.

The flexible spout 20 is made of stainless steel and configured to be bent under some predetermined magnitude of force and then stayed in the given shape even with the force removed.

The flexible shower arm 100 is installed so that the second end portion 19 of the shaft pipe 10 points upward. In such an embodiment, the water pressure into the first first end portion 12 of the shaft pipe 10 is reduced appropriately, so as not to straighten the flexible spout 20.

As shown in FIG. 1, the first end portion 22 of the flexible spout 20 can be inserted deep into the second end portion 19 of the shaft pipe 10 to engage. However, the engaging can be done by conventional methods.

The first first end portion 12 of the shaft pipe 10 may have a dimension of NPT1/2-14, and the second end portion 24 of the flexible spout 20 may have a dimension of NPF1/2-14, in the United States of America to accommodate the standard. Of course, these detailed dimensions do not limit the dimensions.

In some embodiments, the length from the first end portion 12 to the bent portion 16 may be about 4 inches, and the length from the bent portion 16 to the second end portion 19 may be about 3 inches.

Also, each of the first end portion 12 and the second end portion 24 may include other conventional fasteners for engaging them to the water supply device and the shower head, respectively.

While the invention has been shown and described with reference to different embodiments thereof, it will be appreciated by those skilled in the art that variations in form, detail, compositions and operation may be made without departing from the spirit and scope of the invention as defined by the accompanying claims.

What is claimed is:

1. A flexible shower arm for a water supply pipe, the flexible shower arm comprising:
a shaft pipe comprising a first end portion, a first straight pipe portion, a bent portion, a second straight pipe portion, and a second end portion, wherein the first end portion is configured to be connected to the water supply pipe provided generally horizontally; and
a flexible spout comprising a first end portion and a second end portion, wherein the first end portion is configured to be connected to the second end portion of the shaft pipe,
wherein the first and second straight pipe portions meet each other at the bent portion with a predetermined angle so as to reduce water pressure and to prevent the flexible spout from being straightened out because of the water pressure, and
wherein an overall shape of the flexible spout is adjusted so that a vertical location and an angular position of the second end portion of the flexible spout are adjusted.

2. The flexible shower arm of claim 1, wherein the first end portion of the shaft pipe comprises male threads to be received by a female threaded receiver in communication with the water supply pipe.

3. The flexible shower arm of claim 1, wherein the second end portion of the shaft pipe is integrated with the first end portion of the flexible spout.

4. The flexible shower arm of claim 1, wherein the second end portion of the flexible spout is configured to be connected to a shower head.

5. The flexible shower arm of claim 4, wherein the second end portion of the flexible spout comprises male threads adapted to be received by female threaded receiver of the shower head.

6. The flexible shower arm of claim 1, wherein the predetermined angle of the bent portion of the shaft pipe is from about 120 degrees to about 135 degrees.

7. The flexible shower arm of claim 6, wherein the bent portion of the shaft pipe is smoothly curved so as to prevent water flow therethrough from being turbulent.

8. The flexible shower arm of claim 1, wherein the flexible spout is sturdy enough to keep a shape given by a user under a predetermined water pressure.

9. The flexible shower arm of claim 1, wherein the vertical position of the second end portion of the flexible spout is elevated by pushing the second end portion of the flexible spout upward or diagonally.

10. The flexible shower arm of claim 9, wherein the angular position of the second end portion of the flexible spout is changed by pushing, pulling, and twisting the second end portion of the flexible spout.

11. The flexible shower arm of claim 1, wherein the flexible spout is maintained substantially straight within a predetermined length from each of the first and second end portion of the flexible spout.

12. The flexible shower arm of claim 11, wherein the flexible spout is configured to curved without a sharp angle.
